(19) United States
(12) Patent Application Publication
(10) Pub. No.: US 2003/0138227 A1
(43) Pub. Date: Jul. 24, 2003

(54) High power laser head system

(76) Inventor: Michel Moulin, Apples (CH)

Correspondence Address: Paul W Busse, Faegre & Benson, 2200 Wells Fargo Center, 90 South Seventh Street, Minneapolis, MN, 55401-3901, US

(21) Appl. No.: 10/203,097

(22) PCT Filed: Feb. 1, 2001
(86) PCT No.: PCT/US01/40002

(51) Int. Cl. G02B 6/04

(52) U.S. Cl. 385/115; 385/901

(57) ABSTRACT

An optical illumination system for directing the radiant energy produced by an array of high-power laser fibers to a spatial modulator from which selected rays are directed to a media requiring radiation of high radiant intensity includes various lenses and an optical mixer to transfer the high energy beams of the laser emitters to the modulator. More particularly, the illumination system comprises: (a) a plurality of laser radiation sources; (b) means for transmitting rays such as a plurality of optical fibers from the laser sources to means for collimating the rays such as a collimating lens; (c) means for imaging the collimated rays such as a plurality of imaging lenses; (d) means for collimating the imaged rays such as a collimating lens; (e) means for modulating the imaged and collimated rays such as a total internal reflection modulator, wherein focalizing means such as a focalizing lens focalize the imaged and collimated rays on the modulating means; (f) lens means which receive rays from the modulating means; (g) means for separating the diffraction orders of the rays received from the lens means such as a plate having a slit; and (h) imaging means such as a telecentric objective lens for receiving rays from the separating means and forming a reduced image of the modulator.

### CROSS-REFERENCE TO RELATED APPLICATIONS

This application is converted and claims priority from U.S. provisional Patent Application No. 60/180,052 filed Feb. 3, 2000.

### BACKGROUND OF THE INVENTION

1. Field of the Invention

This invention is directed to an illumination system and method for imaging offset plates or films. More particularly, this invention is directed to an illumination system in which optical fibers convey laser light to a modulator which is employed to image a plate or film precursor.

2. Background Information

To image offset plates or films where the image is obtained by sublimation of a thin layer of absorbing matter, a very high density of energy is necessary. In some existing imaging systems using external drums, the imaging laser unit consists of a plurality of individual laser diodes. Each diode is provided with its own power supply and affects a specific imaging area. An optical fiber is associated with each diode to collect the emitted energy. One or several optical means project the image of the output end of the optical fibers to the drum. Each output beam can supply a power up to 0.6 watt on a spot diameter of the order of 25 microns. Arrangements with 32 or 64 beams are complex, expensive and create problems of reliability caused by the large number of components.

As an alternative to the use of individual laser diodes to produce a plurality of light spots, U.S. Pat. No. 4,281,904, incorporated herein by reference, teaches the use of a total internal reflection (TIR) spatial modulator associated with a punctual source. The arrangement allowing the transmission of zero order rays at the exclusion of higher order rays is the best from a transmitted energy point of view, and is preferable for the modulation of high-energy beams. A punctual radiation source can be obtained by the use of a YAG laser, but this approach is expensive and the emitted power is limited. U.S. Pat. No. 5,517,359 (incorporated herein by reference) discloses the use of lenslets to direct the rays emerging from separate emitters to a modulator.

Imaging systems are disclosed, for example in U.S. Pat. No. 6,137,631, U.S. patent application Ser. No. 09/290,829 and International patent application Ser. No. ______ entitled “DEVICE FOR EXPOSING THERMOSENSITIVE MEDIA,” all of which are incorporated herein by reference.

It is an object of the present invention to overcome the limitations and drawbacks of the prior art.

### SUMMARY OF THE INVENTION

The illumination system of this invention comprises:

(a) a plurality of laser radiation sources;

(b) means for transmitting rays such as a plurality of optical fibers from the laser sources to means for collimating the rays such as a collimating lens;

(c) means for imaging the collimated rays such as a plurality of imaging lenses;

(d) means for collimating the imaged rays such as a collimating lens;

(e) means for modulating the imaged and collimated rays such as a total internal reflection modulator, wherein focalizing means such as a focalizing lens focalize the imaged and collimated rays on the modulating means;

(f) lens means which receive rays from the modulating means;

(g) means for separating the diffraction orders of the rays received from the lens means such as a plate having a slit; and

(h) imaging means such as a telecentric objective lens for receiving rays from the separating means and forming a reduced image of the modulator.

According to one embodiment of the present invention a radiation source of very small size whose power is of the order of 100 watts is created by the juxtaposition of optical fiber cores and associated optics with the source to uniformly illuminate a TIR modulator. According to another embodiment of the invention, the output end of one or a group of laser fibers is cemented to an optical mixer in the form of a glass plate. The divergence of the beams entering the modulator are small to allow for the separation of orders whose diffraction angles are also small.

### BRIEF DESCRIPTION OF THE DRAWINGS

FIG. 1 represents schematically the assembly of the laser head according to the present invention.

FIG. 2 represents a preferred arrangement for the integration of several fiber light sources to the head assembly.

FIG. 3 is a partial cross section of a component of FIG. 2.

### DETAILED DESCRIPTION OF THE INVENTION

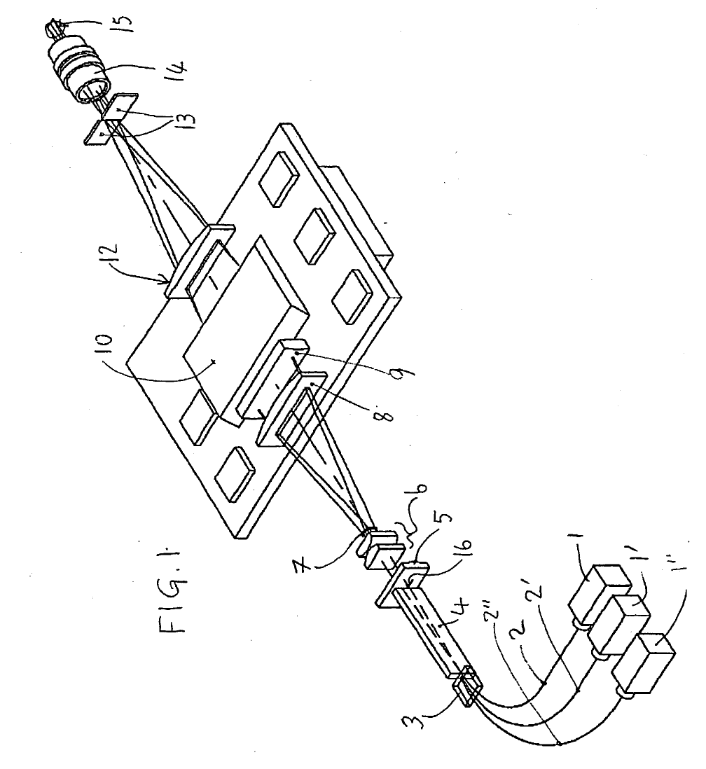

FIG. 1 represents a preferred embodiment the illumination system of this invention. The radiation source consists of the assembly of three fiber lasers individually associated with laser radiation sources 1,1′,1″ separate but preferably operated in unison. Each optic fiber 2, 2′, 2″ preferably has a core diameter of the order of four (4) microns and preferably has a power of the order of thirty (30) watts. The input ends of fibers 2, 2′, and 2″ are connected to sources 1, 1′ and 1″, respectively. The output ends of each fiber are cemented to a junction plate 3 in accurately located etched grooves to position each fiber side by side. The cores of the fibers are thus located on a common plane with a degree of accuracy of the order of one micron. A glass plate 4 approximately 2 centimeters long and a few tenths of a millimeter thick and having input surface 4′ and output surface 4″ is positioned against junction plate 3, adjacent to the output ends of the fiber bundle and at right angles to it. The upper and lower surfaces 3′ and 3″ respectively of junction plate 3 is parallel with the plane of the TIR modulator 10. A cylindrical lens 5 having an axis parallel with the modulator plane is located in proximity to output surface 4″ of glass plate 4 to collimate the beams 50 in the plane perpendicular to the modulator 10.

As disclosed in U.S. Pat. No. 6,137,631, the image 16 of the output end 4″ of glass plate 4 is made on the central plane of modulator 10 by a plurality of (preferably a group of two) cylindrical lenses 6. At the focal point 7 of this lens group 6, the bundle of beams has a minimum width, referred to herein as a “stop”. The distance from this stop to cylindrical collimating lens 8 located at the input to the modulator 10 corresponds to the focal length of lens group 6. The image of the stop is formed on slit 13 of plate 13′, for the separation of orders emerging from lens 12. The width of the slit 13 corresponds to the width of the image of the stop. The rays of the image of this stop of the first order are blocked by the plate 13′. Cylindrical lens 9 focalizes the beam on the active zone of the modulator 10. Telecentric objective 14 forms a reduced image 15 of this zone on a radiation sensitive media (not shown) or on the input of another optical system (not shown). The sensitive media could be either a flat printing plate as shown in WO 00/49463 incorporated herein by reference, or wrapped around a drum as shown in U.S. Pat. No. 4,819,018, incorporated herein by reference.

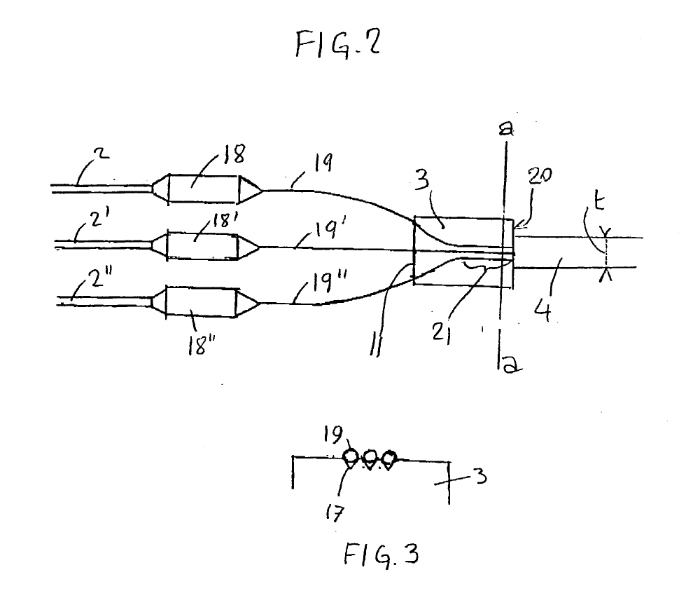

A preferred arrangement of the optic fibers is illustrated in FIG. 2. The beams emerging from the end of each laser fiber 2,2′,2″ are not well defined. For this reason and also for easier construction, the addition of an intermediate array of fibers has been found beneficial. The output ends of each optical laser fiber is accurately centered to the input point of an optical coupler 18, 18′,18″ to transfer the output beams of the small core of each laser fiber to intermediate fibers 19,19′,19″ of larger diameter, hence more easy to handle. These “coupled” fibers coming from the output of each unit can be about 20 microns in diameter. They are directed, fan-wise, to junction plate 3, which as shown in FIG. 2, is provided with etched V-shaped grooves 17 represented as shown in FIG. 3, which is a partial cross section along line a-a′ of junction plate 3. The purposes of grooves 17 are to direct and secure the fibers. Grooves 17 channel the fibers 19, 19′, 19″ arriving fan-wise at the first end 11 of plate 3 (FIG. 2) to second end 20. From their fanshaped form, the grooves 17 reside in straight parallel sections 21, accurately located, spaced by approximately 20 microns and exactly perpendicular to second end 20 of junction plate 3. Perfect alignment of the ends of the fibers 19, 19′ 19″ and their perpendicularity to the face of second end 20 of junction plate 3 are thus insured by the grooves 17 in which they are secured. They are also positioned lengthwise so that their radiation emitting cores end up flush with the face of second end 20 of junction plate 3 to which glass plate 4 is cemented to insure good optical coupling.

The arrangement just described makes it possible to generate an array of 64 beams shown in FIG. 1 as impinging on media 15, with each beam carrying a power of more than 0.5 watt. This is not a limit and more beams could be provided. Although three laser optical fibers have been described, this number can be increased, to effectively produce at the output end of junction plate 3 the equivalent of a single radiation source relative to the downstream optical system employed therewith. The arrangement as per the invention makes it possible to sublimate absorbing layers on a substrate and thus produce images without any chemical process.

It will be understood that the exemplary embodiments described herein in no way limit the scope of the invention. Other modifications of the invention will be apparent to these skilled in the art in view of the foregoing descriptions. Accordingly, the invention is not limited to the described embodiments and all alternative modifications and variations of the present invention which fall within the spirit and scope of the appended claims are within the scope of this invention.

1. An illumination system comprising:
(a) a plurality of laser radiation sources;
(b) means for transmitting rays from the laser sources to means for collimating the rays;
(c) means for imaging the collimated rays;
(d) means for collimating the imaged rays;
(e) means for modulating the imaged and collimated rays, wherein focalizing means focalize the imaged and collimated rays on the modulating means;
(f) lens means which receive rays from the modulating means;
(g) means for separating the diffraction orders of rays received from the lens means; and
(h) imaging means for receiving rays from the separating means and forming a reduced image of the modulator.

2. The system of claim 1, in which the means for transmitting radiant energy comprises a plurality of optic fibers connected to a junction plate which is connected to a light transmission plate.

3. The system of claim 1, in which the means for collimating rays from the laser sources is a collimating lens.

4. The system of claim 1, in which the means for imaging the collimated rays is a plurality of imaging lenses.

5. The system of claim 1, in which the means for collimating the imaged rays is a collimating lens.

6. The system of claim 1, in which the modulating means is a total internal reflection modulator.

7. The system of claim 1, in which the focalizing means is a focalizing lens.

8. The system of claim 1, in which the lens means receiving rays from the collimating means is a lens.

9. The system of claim 1, in which the means for separating the diffraction orders of rays is a plate having a slit.

10. The system of claim 1, in which the imaging means for receiving rays from the separating means is a telocentric objective lens.

11. An illumination system comprising:
(a) a plurality of laser radiation sources;
(b) a plurality of fibers, wherein each fiber is connected at a first end to the corresponding laser radiation source and is connected at a second end to a junction plate capable of positioning the fibers side by side;
(c) a light transmissive plate having input and output ends, wherein the input end of the light transmissive plate is coupled to and receives rays from the junction plate (3);
(d) a first collimating lens which receives rays from the output end of the light transmissive plate;
(e) a plurality of imaging lenses capable of forming the image of the output end of the light transmissive plate from the rays received from the light transmissive plate (4);
(f) a second collimating lens which receives rays from the plurality of imaging lenses (6);
(g) a first focalizing lens which receives the imaged rays from the second collimating lens;
(h) a modulator which receives the imaged rays from the first focalizing lens;
(i) a second focalizing lens which receives the imaged rays from the modulator;
(j) a plate having a slit, wherein the plate receives imaged rays from the second focalizing lens; and
(k) a telecentric objective lens which receives that portion of the imaged rays which passes through the slit and is capable of forming a reduced image of the modulator.

12. An illumination system comprising:
(a) a plurality of laser radiation sources:
(b) a plurality of first fibers having first and second ends capable of transmitting rays from the laser sources, wherein each first fiber is connected at a first end to the corresponding laser radiation source;
(c) a plurality of optical couplers having input and output ends, wherein each optical coupler is connected at its input end to the second end of each corresponding first fiber;
(d) a plurality of second fibers having first and second ends, wherein each second fiber is connected at a first end to the output end of the corresponding optical coupler;
(e) a junction plate having front and back ends, the front end receiving the second ends of the plurality of second fibers and arranging the second fibers parallel to each other, and perpendicular and coterminal with the back end of the junction plate;
(f) a light transmissive plate having input and output ends, wherein the input end is coupled to the back end of the junction plate;
(g) means for collimating rays received from the output end of the light transmissive plate;
(h) means for imaging the collimated rays;
(i) means for collimating the imaged rays;
(j) means for modulating the imaged and collimated rays, wherein focalizing means focalize the imaged and collimated rays on the modulating means;
(k) lens means which receive rays from the modulating means;
(l) means for separating the diffraction orders of rays received from the lens means; and
(m) imaging means for receiving rays from the separating means and forming a reduced image of the modulator.

13. The system of claim 12, in which the means for collimating the rays received from the output end of the light transmissive plate is a collimating lens.

14. The system of claim 12, in which the means for imaging the collimated rays is a plurality of imaging lenses.

15. The system of claim 12, which the means for collimating the imaged rays is a collimating lens.

16. The system of claim 12, in which the modulating means is a total internal reflection modulator.

17. The system of claim 12, in which the focalizing means is a focalizing lens.

18. The system of claim 12, in which the lens means receiving rays from the collimating means is a focalizing lens.

19. The system of claim 12, in which the means for separating the diffraction orders of the rays is a plate having a slit.

20. The system of claim 12, in which the imaging means for receiving rays from the separating means is a telocentric objective lens.

21. An illumination system comprising:
(a) a plurality of laser radiation sources;
(b) a plurality of first fibers having first and second ends capable of transmitting rays from the laser sources, wherein each first fiber is connected at a first end to the corresponding laser radiation source;
(c) a plurality of optical couplers having input and output ends, wherein each optical coupler is connected at its input end to the second end of each corresponding first fiber;
(d) a plurality of second fibers having first and second ends, wherein each second fiber is connected at a first end to the output end of the corresponding optical coupler;
(e) a junction plate having front and back ends, the front end receiving the plurality of second fibers and arranging the second fibers parallel to each other, and perpendicular and coterminal with the back end of the junction plate;
(f) a light transmissive plate having input and output ends, wherein the input end is coupled to the back end of the junction plate, and the light transmissive plate (4) input end receives radiant energy from the junction plate;
(g) a first collimating lens which collimates rays received from the output end of the light transmissive plate;
(h) a plurality of imaging lenses which receive rays from the output end of the light transmissive plate;
(i) a second collimating lens which receives rays from the plurality of imaging lenses (6);
(j) a first focalizing lens which receives rays from the second collimating lens (8);
(k) a modulator which receives rays from the first focalizing lens;
(l) a second focalizing lens which receives rays from the modulator;
(m) a plate having a slit, wherein the plate receives rays from the second focalizing lens; and
(n) a telecentric objective lens which receives that portion of the imaged rays which pass through the slit and forms a reduced image of the modulator.
